(19) United States
(12) Patent Application Publication
(10) Pub. No.: US 2015/0231922 A1
(43) Pub. Date: Aug. 20, 2015

(54) BEARING COVER, IN PARTICULAR, AN ABS SENSOR CAP

(71) Applicant: SCHAEFFLER TECHNOLOGIES AG & CO. KG, Herzogenaurach (DE)

(72) Inventors: Andreas Kaiser, Werneck (DE); Frank Eichelmann, Hassfurt (DE); Ralf Heiss, Schweinfurt (DE); Kay Schumacher, Stadtlauringen (DE)

(73) Assignee: Schaeffler technologies AG & Co. KG, Herzogenaurach (DE)

(21) Appl. No.: 14/429,571

(22) PCT Filed: Aug. 6, 2013
(86) PCT No.: PCT/DE2013/200098

§ 371 Date: Mar. 19, 2015

(30) Foreign Application Priority Data
Sep. 21, 2012 (DE) 10 2012 217 030.8

(51) Int. Cl. B60B 27/00; F16C 33/78; F16C 41/00

(52) U.S. Cl. CPC B60B 27/0073; F16C 41/007; F16C 33/7816; F16C 33/7833

(57) ABSTRACT

A bearing cover for separating an inner region of a bearing from the environment. The bearing cover according to the invention includes: an annular edge section (1) which is at a spacing from a bearing axis (X) and can be mounted in sealing manner on a connection region; a cover section (2) which extends in a region surrounded by the annular edge section and adjoins the latter; and a membrane element (3) which is designed as a gas-permeable membrane and enables pressure to be equalized between the bearing inner region and the environment. An opening section (4) is formed in the cover section at a location offset radially from the bearing axis and towards the annular edge, and the membrane element is disposed in this opening section which is radially offset from the bearing axis.

### FIELD OF THE INVENTION

The invention relates to a bearing cover, in particular, in the form of an ABS sensor cap, which is arranged, as such, in the area of a wheel bearing and, on one hand, covers a multiple-pole ring that also revolves on the side of the hub when the vehicle is running and, on the other hand, carries a sensor that detects the alternating magnetic field generated by the multiple-pole ring.

### BACKGROUND

Designs for bearing arrangements, in particular, wheel bearing arrangements, have larger widths than permanently lubricated roller bearing arrangements. Such permanently lubricated roller bearing arrangements are typically sealed by means of elastic sealing rings that possibly form multiple sealing lips and are arranged in the direct vicinity of the surrounding track area of the roller bodies. Furthermore, the sealing rings can be covered by plate-like or ring-like covers, in order to counteract the penetration of contaminants and moisture to the sealing gap area sealed by the sealing rings and thus to protect the sealing rings. For the use of such covers, due to temperature fluctuations caused by operation, the pressure in the interior of the covers can fluctuate, and these pressure fluctuations can have the effect that lubricant migrates out from the bearing or moisture penetrates into the bearing. As far as communication between the interior of the covers and the surroundings is permitted, condensate can form in any interior of the covers.

From U.S. Pat. No. 7,357,709 B2, a ventilation element is known that has a pot-like structure and is equipped in its interior with a membrane that allows gas passage. This ventilation element can be placed on a housing device and allows, via the specified membrane, an equalization of the pressure within the housing device to the ambient pressure, wherein particles and drops of water are held back by the membrane.

From DE 3 923 530 A1, an insert element is also known that forms a pressure equalization channel guided over several membrane elements. The membrane elements are arranged so that, when pressure differences occur, these elements initially bulge out. This realizes a certain self-cleaning effect.

From DE 694 203 578 A1, a roller bearing is known that is provided with a bearing sealing ring in which a membrane structure is included. By the use of this membrane structure, a pressure equalization is permitted between the interior of the bearing and the surroundings.

The invention is based on the objective of creating solutions through which it is possible to advantageously partition the interior of a bearing arrangement, in particular, a wheel bearing arrangement equipped with an ABS sensor, from the surroundings.

### SUMMARY

This objective is met according to the invention by a bearing cover for partitioning a bearing interior relative to the surroundings, with:
An annular edge section that is spaced apart from a bearing axis and can be placed, forming a seal, on an attachment area,
A cover section that extends in an area surrounded by the annular edge section and connects to the annular edge section, and
A membrane element that is constructed as a gas-permeable membrane and permits pressure equalization between the bearing interior and the surroundings,
Wherein, in the cover section at a position offset from the bearing axis in the radial direction toward the annular edge, an opening section is formed and the membrane element is arranged in this opening section offset relative to the bearing axis in the radial direction.

In this way it is advantageously possible to permit pressure equalization by means of a membrane element integrated in the bearing cover and in this way to position the membrane element over the bearing cover such that this is located in an area of the bearing arrangement offset toward the top in a vertical direction relative to the bearing axis.

The membrane element advantageously is formed of a jacketed fabric material, in particular, a fabric material with warp and weft threads that are jacketed or coated with PTFE. The membrane element can be designed so that it is both hydrophobic and also lipophobic. The membrane element can be constructed so that it has several material layers, e.g., two fabric layers and a nonwoven layer in-between. The fabric layers can be alternately hydrophobic and lipophobic.

According to one especially preferred embodiment of the invention, the bearing cover is made from a plastic material, in particular, an injection-molded or blow-molded part. The bearing cover advantageously represents a plate-shaped or ring-shaped structure that is anchored by a clamping fit or interference fit on a corresponding counterpiece, in particular, pressed onto or into this counterpiece.

The membrane element is advantageously connected materially to the bearing cover, in particular, welded or bonded. As an alternative to a material connection of the membrane element to the bearing cover, it is also possible to fix, in particular, clamp, the membrane element mechanically on the bearing cover or to anchor it by a different kind of holding structure.

Advantageously it is possible to form, in the area of the opening section, a support structure integrated with the bearing cover in the form of a grating that supports, as such, the membrane element. As an alternative, it is also possible to incorporate such a support grating in the form of an intermediate layer in the membrane element.

One embodiment of the invention that is advantageous especially for the realization of an ABS encoder arrangement is given in that the opening section is surrounded on the cover outer side facing away from the bearing interior by a connector socket section that is used to hold a connector element. For the realization of an ABS encoder arrangement, the position of the opening section in the bearing cover is adjusted such that the opening section is located in the vicinity of a multiple pole wheel of the ABS encoder arrangement. Each connector element then forms a field sensor that is correctly positioned relative to the multiple pole wheel after insertion into the connector socket section. Due to the thin walls of the membrane element, an advantageous field transfer is produced.

According to one especially preferred embodiment of the invention, it is also possible to adjust the connector element and the connector socket section relative to each other with respect to their outer geometries such that these two components form, in the joined together state, one channel cross section that allows gas exchange via the membrane element. This channel cross section can be shaped so that it has one or more channels extending in straight lines in the connector insertion direction. However, it is also possible, especially by means of the outer walls of the connector element, to form a labyrinth structure that then forms, in interaction with the inner walls of the connector socket section, an extended gas transfer channel that tends to have, due to its intrinsic geometry, retention characteristics for droplets and particles. This gas transfer channel can be checked for clearance by pulling the connector element and optionally cleaned by brushes or blowing air through the labyrinth structure on the connector element.

According to another especially preferred embodiment, it is possible to create, through shaping the connector element and optionally also the end area of the connector socket section, a cap structure that, as such, shields the channel system running within the connector socket section from spray water and splash water and guarantees an advantageous alignment and arrangement of the access opening.

To guarantee the most secure anchoring of the bearing cover possible, the bearing cover is advantageously formed as an insert molding part and provided, in the area of the annular edge section, with a support ring that stiffens the bearing cover.

The design according to the invention is suitable in an especially advantageous way for the ventilation and dehumidification of sealed bearing positions and bearing housings, especially wheel bearings. The design according to the invention achieves an especially efficient support of the “breathing function” of a sealed unit. The design according to the invention allows pressure equalization and thus a prevention of water ingress due to low pressure, a prevention of grease discharge due to over pressure, and the transport of moisture. The solution according to the invention can be realized in the form of a long service life component. This component can be produced economically and is largely resistant to soiling.

According to the invention, a membrane (in principle Gore-Tex) is mounted on the housing of a closed system. The mounting can be realized, e.g., by fusing a membrane on a wheel bearing ABS sensor cap. The membrane attached according to the invention allows an escape of moisture from the bearing interior. The invention further allows the equalization of pressure differences between the installation space and the surroundings (e.g., by heating and cooling the bearing points during operation).

The membrane can be fixed directly on the housing by adhesion, welding, or injection molding. It is also possible to enclose a housing hole with a kind of plug with machined membrane (e.g., press in, bond, screw in plugs).

### BRIEF DESCRIPTION OF THE DRAWINGS

Additional details and features of the invention can be found in the following description in connection with the drawing. Shown are:

FIG. 1 a top view of a bearing cover according to the invention for an ABS encoder arrangement,

FIG. 2 a section view for illustrating the internal structure of the bearing cover according to FIG. 1,

FIGS. 3a, 3b additional views for illustrating details of the bearing cover according to the invention according to FIGS. 1 and 2, now with inserted connector element,

FIG. 4 a perspective view of a wheel bearing that is closed on the back side with a bearing cover according to the invention,

FIG. 5 an axial section view of a bearing arrangement that is closed in the axial direction with a bearing cover formed according to the invention,

FIG. 6 a perspective view of an insertion element that is provided on the inside with a pressure equalizing membrane, and

FIG. 7 an axial section view of a bearing arrangement in which an insertion element according to FIG. 6 is provided.

### DETAILED DESCRIPTION OF THE PREFERRED EMBODIMENTS

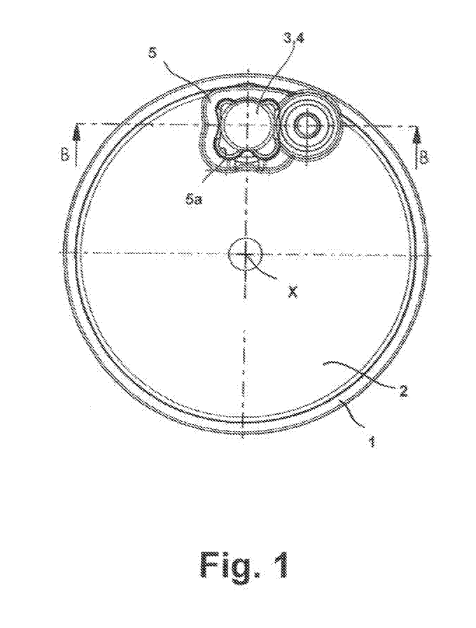

In FIG. 1, a bearing cover according to the invention is shown. This bearing cover is used for partitioning a bearing interior area from the surroundings. The bearing cover comprises an annular edge section 1 that is spaced apart from a bearing axis X and is here, in particular, concentric to the bearing axis X and can be placed, forming a seal, on an attachment area of a bearing carrier not shown here in more detail. The bearing cover further comprises a cover section 2 that extends in an area surrounded by the annular edge section 1 and connects to the annular edge section 1.

The bearing cover is provided with a membrane element 3 that is constructed as a gas-permeable membrane and allows pressure equalization between the bearing interior area and the surroundings. This membrane element sits on an opening section 4. This opening section 4 is formed in the cover section 2 at a position offset from the bearing axis X toward the annular edge 2 in the radial direction. The membrane element 3 completely covers this opening section 4 offset in the radial direction relative to the bearing axis X.

The bearing cover shown here is formed as an injection molded part made from plastic material. The membrane element 3 is welded with the bearing cover by a fused weld seam.

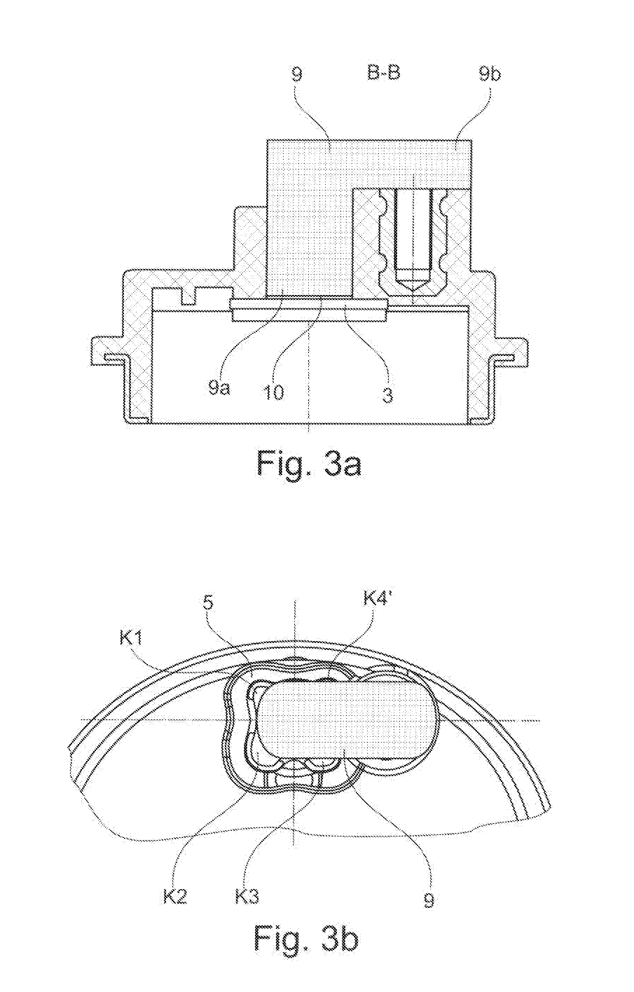

The opening section 4 is surrounded by a connector socket section 5 on the cover outer side that can be seen here and faces away from the bearing interior area. This connector socket section 5 is used to hold a connector element (cf. FIG. 3a). The inner walls 5a of the connector socket section are shaped so that they form several channels in interaction with the outer circumferential walls of a connector not shown here in more detail.

The bearing cover shown here forms part of an ABS encoder arrangement. The position of the opening section 4 in the bearing cover is adjusted such that the opening section 4 is located close to a multiple-pole wheel of the ABS encoder arrangement that cannot be seen here and is concentric to the bearing axis X.

The connector socket section 5 forms a receptacle for an ABS sensor. This sensor can make measurements through the thin-wall membrane element according to the invention. The walls in this area are made from a membrane material according to the invention. Air exchange is possible at the sides of the sensor.

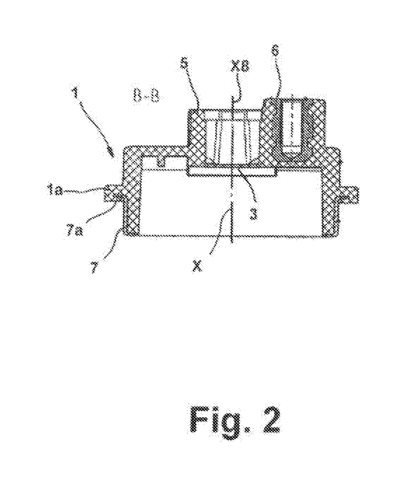

In FIG. 2, the structure of the bearing cover according to FIG. 1 is further shown. The representation according to FIG. 2 is a sectional view showing the cross section in the section plane B-B shown in FIG. 1.

As can be seen, the base area of the connector socket section 5 is covered by the membrane element 3. The membrane element is welded in the area of its outer edge from the inside with the bearing cover. A threaded socket 6 is provided in the direct vicinity of the connector socket section 5. This threaded socket is formed as an insert molding structure in the bearing cover and is used to hold a securing bolt for securing the sensor connector shown in FIG. 3a. The threaded socket is made from a corrosion-resistant, non-magnetic metal material, advantageously brass. The bearing cover is further provided with a seat annular insert 7 that is here made as a drawn sheet metal annular part and is similarly shaped in the bearing cover during the course of an insert molding process.

The seat annular insert 7 forms an annular bar 7a projecting in the radial direction. The bearing cover forms, in the area of an annular edge region 1, an annular flange 1a that defines, as such, an axial press-in position of the bearing cover. The annular bar 7a of the seat annular insert extends in the interior of this annular flange 1a and reinforces this flange.

The membrane element 3 is arranged in the embodiment according to the invention shown here such that it is oriented essentially perpendicular to the connector insertion axis X8. The connector insertion axis X8, in turn, runs essentially parallel to the wheel bearing axis X (cf. also FIG. 1) that is aligned in this representation with the connector insertion axis X8.

In FIGS. 3a and 3b, the bearing cover according to the invention from FIGS. 1 and 2 is shown in a state now equipped with an ABS sensor connector 9. The sensor connector 9 comprises a sensor head 9a that extends to the membrane element 3 while leaving a small air gap 10. At the end face of the sensor head 9a, individual, small spacer structures, for example, small bumps or bars, could be formed that, as such, contact the membrane element 3 and maintain the required minimum distance. The sensor connector 9 comprises a holding section 9b that covers the area of the threaded socket 6 and can be secured on the threaded socket 6 by means of a bolt not shown in more detail here.

Although it is not shown here, it is possible to provide a bar or grating structure that supports the membrane element on the side of the membrane element facing away from the sensor connector 9.

As can be seen, in particular, from the representation according to FIG. 3b, the inner walls 5a of the connector socket section 5 form, in interaction with the outer walls of the sensor connector 9, in particular, of the sensor head 9a of this connector, several channels K1, K2, K3, K4 (K4 is almost completely hidden). By means of these channels K1, K2, K3, K4, the air gap region 10 that can be seen in FIG. 3a communicates with the outer surroundings. The channels K1, K2, K3, and K4 are produced from the special, here polygon, profile of the inner walls 5a of the connector socket section 5 relative to the outer walls of the sensor connector 9.

In the installed state of the bearing cover, the sensor connector 9 is then located at a position that allows a detection of a magnetic field generated by a multiple pole ring.

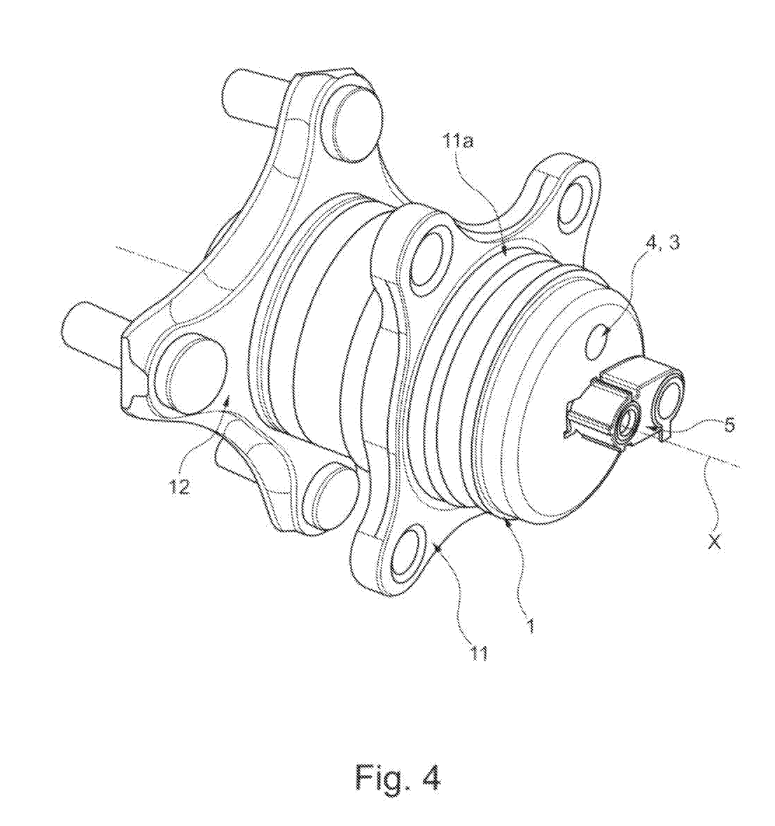

In FIG. 4, in the form of a perspective representation, a wheel bearing arrangement for a non-driven vehicle axle is shown. The wheel bearing arrangement comprises a wheel bearing carrier 11 that holds a wheel bearing, for example, in the form of a double-row angular contact ball bearing. This wheel bearing then supports the wheel hub 12 that can be seen here so that it can rotate on the wheel bearing carrier.

On one side of the wheel bearing carrier facing away from the wheel hub 12, this forms a collar 11a concentric to the bearing axis X. The bearing cover 14 shaped according to the invention is pressed into the collar 11a with its seat annular insert 7 (cf. FIG. 2) and closes the rear area of the bearing device and thus partitions the bearing interior area relative to the surroundings.

The bearing cover comprises, as described, an annular edge section that is spaced apart from the bearing axis X and is concentric, in particular, to the bearing axis X and can be positioned, forming a seal, on the attachment area formed here by the collar 11. The cover section 2 of the bearing cover extends in an area surrounded by the annular edge section and connects to the annular edge section 1.

In the cover section 2, an opening section is formed at a position offset from the bearing axis X in the radial direction relative to the annular edge 1. In the area of this opening section, a membrane element 3 that is constructed as a gas-permeable membrane and allows pressure equalization between the bearing interior area and the surroundings is positioned on the bearing cover.

The bearing cover is also provided here with a connector socket section 5 in which a sensor connector that is not shown in more detail here can be inserted.

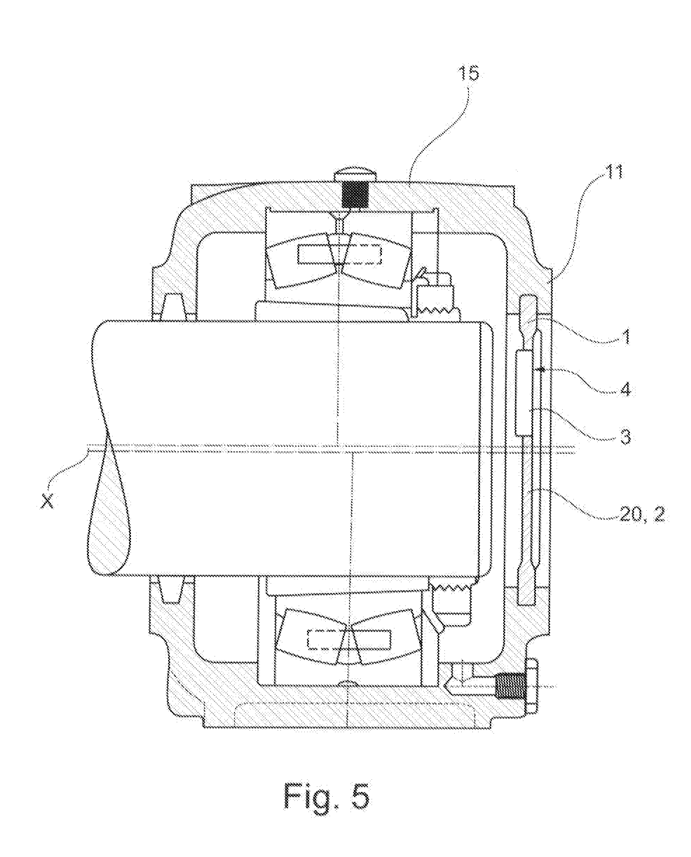

In FIG. 5, a bearing arrangement with a self-aligning roller bearing is shown in the form of an axial section view. The bearing arrangement comprises a bearing housing 15 that is closed on one side with a bearing cover 20. In this embodiment, the bearing cover 20 also comprises an annular edge section 1 that is spaced apart from the bearing axis X and is concentric, in particular, to the bearing axis X and can be placed, forming a seal, on the attachment area 11 formed here by the bearing housing 15. The cover section 2 of the bearing cover extends in an area surrounded by the annular edge section 1 and connects to the annular edge section 1.

In the cover section 2, an opening section 4 is formed at a position offset from the bearing axis X in the radial direction relative to the annular edge 1. In the area of this opening section 4, a membrane element 3 that is constructed as a gas-permeable membrane 20 and allows pressure equalization between the bearing interior area and the surroundings is placed on the bearing cover.

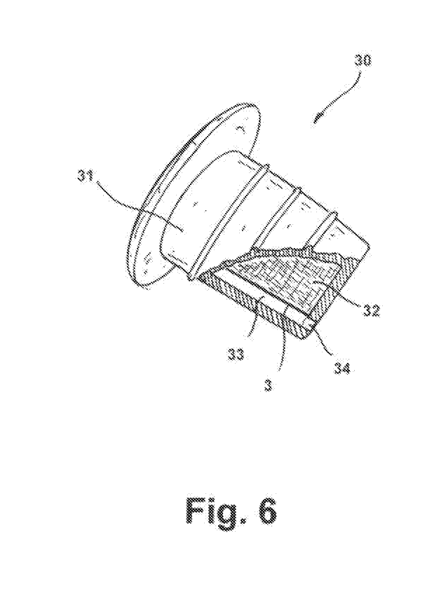

In FIG. 6, an insert element 30 that comprises a pin body 31 made from a plastic material is shown in the form of a perspective view. The pin body 31 forms an interior 32. In this interior 32 sits a membrane element 3 that is made from a gas-permeable fabric material. In the embodiment shown here, the inner walls of the pin body 31 have several support bars 33 that are spaced apart from each other and contact only one part of the outer side of the membrane element 3 and here form gas transfer grooves. The membrane element 3 sits on parts of these support bars 33. The base area of the pin body 31 is covered by base walls. Through holes 34 are formed in these base walls. These through holes 34 communicate with the groove spaces that are each covered by the membrane element 3 and lie between the support bars 33. By means of the structure built in this way, it is possible to cover a large interior area of the pin body 31 with the membrane element 3 and thus to create a relatively large gas exchange area. As an alternative to the embodiment described here, it is also possible to arrange the membrane element 3 in the base area of the pin body 31. The membrane element 3 can here form a cylindrical or conical socket. The membrane element could also be formed as a socket folded into a star shape in cross section. The membrane element could also be formed as a pot-shaped socket with side walls and base walls.

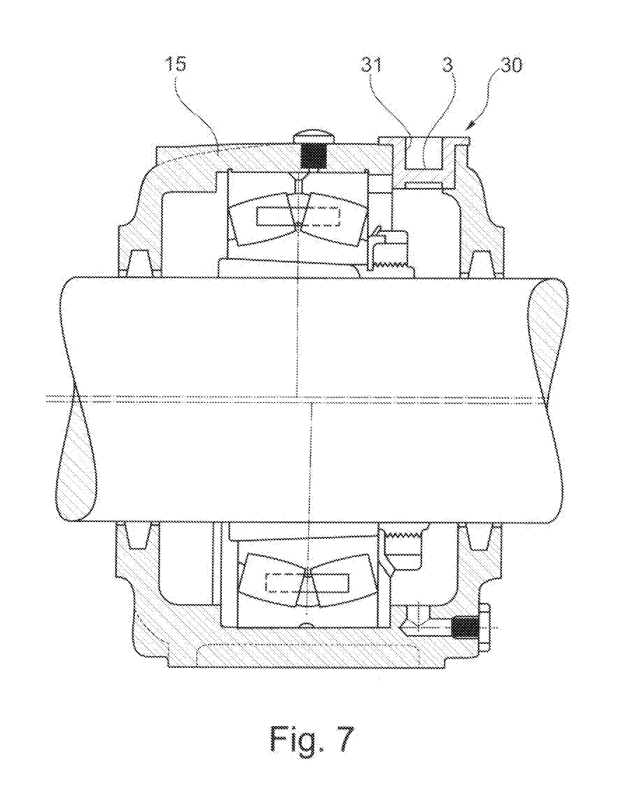

In FIG. 7, in the form of an axial section view, a self-aligning roller bearing arrangement is shown that has, as such, a double-row self-aligning roller bearing that is held in a bearing housing 15. The bearing housing 15 is provided with an insert opening in an area at the top in the installation position. In this insert opening sits an insert element 30 that has a pin body 31 made from a plastic material and a membrane element 3. The membrane element 3 forms a gas-permeable diaphragm and allows equalization of the pressure in the interior of the bearing housing 15 at the ambient pressure.

### LIST OF REFERENCE NUMBERS

X Bearing axis

1 Annular edge section

1a Annular flange

2 Cover section

3 Membrane element

4 Opening section

5 Connector socket section

5a Internal wall

6 Threaded socket

7 Seat annular insert

7a Annular bar

X8 Connector push-in axis

9 ABS sensor connector

10 Air gap

K1 Channel

K2 Channel

K3 Channel

K4 Channel

11 Wheel bearing carrier

11a Collar

12 Wheel hub

15 Bearing housing

20 Bearing cover

30 Insertion element

31 Pin body

32 Internal space

33 Support bars

34 Through holes

1. A bearing cover for partitioning a bearing device from surroundings, comprising:
an annular edge section that is spaced apart from a bearing axis (X) and is settable, on an attachment area to form a seal,
a cover section that extends in an area bordered by the annular edge section and connects to the annular edge section, and
a membrane element that is formed as a gas-permeable membrane and allows pressure equalization between an interior area of the bearing cover and the surroundings,
wherein, in the cover section at a point offset from the bearing axis (X) toward the annular edge in a radial direction, an opening section is formed and the membrane element is arranged in said opening section offset relative to the bearing axis (X) in a radial direction.

2. The bearing cover according to claim 1, wherein the bearing cover is made from a plastic material.

3. The bearing cover according to claim 1 wherein the membrane element is welded or bonded to the bearing cover.

4. The bearing cover according to claim 1, wherein at the membrane element is clamped or anchored onto the bearing cover.

5. The bearing cover according to claim 1, wherein in an area of the opening section, a support structure that is integral with the bearing cover is constructed in formed as a grating.

6. The bearing cover according to claim 1, wherein a the opening section is bordered on an outside of the cover facing away from the bearing interior area by a connector socket section that is used for holding a connector element.

7. The bearing cover according to claim 6, wherein the bearing cover forms part of an ABS encoder arrangement and a position of the opening section is aligned in the bearing cover such that the opening section s located in the proximity to a multiple-pole wheel of the ABS encoder arrangement.

8. The bearing cover according to claim 7, wherein each the connector element comprises a field sensor.

9. The bearing cover according to claim 7, wherein 19 the connector element and the connector socket section are aligned to each other such that a channel cross section (K1, K2, K3, K4) is formed in a joined-together state.

10. The bearing cover according to claim 1, wherein the cover element is manufactured as an insert molding part and a support ring is provided in an area of the annular edge section.
